(19) United States
(12) Patent Application Publication
(10) Pub. No.: US 2012/0260108 A1
(43) Pub. Date: Oct. 11, 2012

(54) FONT ENCRYPTION AND DECRYPTION SYSTEM AND METHOD

(76) Inventor: Steve Lee, San Jose, CA (US)

(21) Appl. No.: 13/084,162

(22) Filed: Apr. 11, 2011

(51) Int. Cl. G06F 12/14

(52) U.S. Cl. 713/191; 713/189

(57) ABSTRACT

Systems and methods in accordance with aspects of the present invention can be implemented to prevent automated, semi-automated, or manual searching, indexing, copying, and surveillance of electronic content, e.g., content in online documents or pages. Such systems and methods can also enable a human user to see the electronic content properly on a display, while the content remains unintelligible to computer programs. Thus, in accordance with the present invention, a computer application and a human user can interpret or “see” an electronic document differently.

### FIELD OF INTEREST

The present inventive concepts relate to the field of electronic documents and communications, and more particularly to the field of electronic document and communications security.

### BACKGROUND

For a vast number of reasons, the protection of electronic content is very important, such as for protecting the confidential nature of intellectual property, human identities, plans, strategies, and the like. As we rely on connected mediums, like Internet or private networks, to provide the content, the protection of online or electronically communicated or stored content is critical. For instance, many types of electronic content is made available, for which the owners or relevant others prefer or require that typical copying, downloading, or distributing technologies not be useful in producing readable versions of their electronic content. For instance, online documents, such as copyrighted electronic documents, have very little protection once made available on the Web.

Documents can be encrypted as a means of security, which means the contents are scrambled or reorganized by a special encryption program—using an encryption algorithm (or “key”). The encrypted document is unreadable to any computer not in possession of the proper decryption key (or algorithm). To process an encrypted document, the receiving computer also needs the encryption program to decrypt the document—using a decryption algorithm (or key). Once decrypted, the electronic document can be used by the appropriate application, and the contents can be copied. As a result, application (or computer) readability and human readability together exist or do not exist. This may suffice in some situations, but may also be impractical, cumbersome or ineffective in others. For example, users are very mobile these days, and may want to be able to read documents on one of many private or public devices, not all of which may include the required decryption program and key. Therefore, the computer and user may not be able to read such documents in those situations. Also, someone may want a document to be public on their own Web site, but not copied or downloaded, or even searchable. Standard encryption does not address such issues.

Computer applications use documents character encoding to interpret the content of an electronic document and the human user sees the resulting character glyphs displayed in the monitor to interpret the content. All electronic documents follow character encoding standards, like ASCII (e.g., see http://en.wikipedia.org/wiki/ASCII) representing Latin characters (see the ASCII Table in FIG. 1A) or Unicode representing all of the world languages characters (see, e.g., http://en.wikipedia.org/wiki/Unicode).

Fonts are typically local to a computer, and used by applications executed by the computer. However, when downloading documents via a browser, the browser can fetch and download a font for the document. The font downloaded is still an ASCII or Unicode standard font—as appropriate for the downloaded document.

FIG. 1B provides a high level block diagram representation of how such systems function according to known techniques. A system 100, or an application running thereon, can receive an electronic document 10 from another system or server or other source 102, and attempt to open the document 10. When a computer program or application 20, like a Windows or Mac system or a browser, e.g., Internet Explorer, processes electronic document 10 containing the character code 101, it will display the character (or glyph) “A,” for character code 102 it will display “B,” for character code 103 it will display “C,” and so on.

Document 10 may have been downloaded via a browser with a standard font 30, or standard font 30 can be locally available—and typically is. A computer application 20 running on computer system 100 must obtain the physical character glyph (graphical representation of a character, like the image of “A”) from standard font table 30 and render it to the display device 40.

When application 20 requests a character glyph, it will follow the font data structure to get the character glyph, as described with respect to FIG. 1B. The standard font data structure has “Character Encoding,” which corresponds to font encoding standards like ASCII and Unicode. Each character encoding points to a Glyph Index Pointer, which in-turn points to the actual glyph.

The general format for a font data structure is shown in Table 1, and is:

TABLE 1
Standard Font

| Character | Glyphs Index | Character |
|---|---|---|
| Encoding | Pointer | Glyphs |
| 101 | 200 | ‘A’ |
| 102 | 201 | ‘B’ |
| 103 | 202 | ‘C’ |
| 104 | 203 | ‘D’ |
| 105 | 204 | ‘E’ |

Thus, as shown in Table 1, when an electronic document includes the Character Encoding (or code) 101, a Glyph Index Pointer 200 which points to the glyph “A” will cause glyph “A” to be returned to the application for display.

The character encoding is very important in document searching, e.g., in a Web browser context. For instance, a keyword search for documents will interpret the keywords in accordance with the standard font table. That is, the keyword “patent” will be represented in accordance with the standard Character Encoding, and documents having the same Character Encoding (i.e., for the word “patent”) will be recognized and returned. If a document does not include the character encoding for the word “patent” it will not be returned in the search.

In addition to electronic documents, electronic inputs to Web pages has also become a concern. In particular, login information to a secure sight is critical information, and the detection of such login information can have disastrous effects of individuals. For example, obtaining the login information for someone's bank account to could to property or identity theft.

To address this problem, and many others, a mechanism has been developed to provide a computer-unreadable input that is human readable. The mechanism is called “CAPTCHA,” which stands for Completely Automated Public Turing Test To Tell Computers and Humans Apart, and was coined in 2000 by Luis von Ahn, Manuel Blum, Nicholas Hopper and John Langford of Carnegie Mellon University. In short, a CAPTCHA is a program that can generate and grade tests that humans can pass but current computer programs cannot. For example, humans can read distorted text presented as an image, as the one shown in FIG. 1C, but current computer programs cannot. The user is given instructions to type in distorted text into a CAPCHTA input field.

Using CAPTCHAs, images of text are preferably distorted randomly before being presented to the user. Implementations of CAPTCHAs that use undistorted text, or text with only minor distortions, are vulnerable to simple automated attacks. For example, the CAPTCHAs shown in FIG. 1D can all be broken using image processing techniques, mainly because they use a consistent font.

Another problem with CAPTCHA, however, is that sometimes it is difficult for a human to read the image correctly, such as those shown in FIG. 1C.

### SUMMARY

Systems and methods in accordance with aspects of the present invention can be implemented to prevent automated, semi-automated, or manual searching, indexing, copying, and surveillance of electronic content, e.g., content in online documents or pages. Such systems and methods can also enable a human user to see the electronic content properly on a display, while the content remains unintelligible to computer programs. Thus, in accordance with the present invention, a computer application and a human user can interpret or “see” an electronic document differently.

In accordance with some aspects of the present invention, new font tables are generated and used with electronic documents. The new font tables use non-standard character encoding. For example, glyph index pointers can be assigned to characters in a non-standard manner. This can be referred to as “encrypted fonts,” which alter selected text in an electronic document on a character-by-character basis. A “matching encrypted font” is a non-standard font table that has character encoding that enables correct interpretation of the encrypted text. The matching encrypted font is required to allow a character encrypted document, i.e., one encrypted using an encrypted font, to be properly displayed on a computer screen for a human user. The matching encrypted font is used by a computer application, e.g., browser or word processor, in place of the standard font so that the encrypted text can be displayed correctly. If the standard font was used by the application to open a character encrypted document, the character encrypted text would not appear properly on the display—it would look to the user as a collection of characters having no particular meaning.

Also, while a matching encrypted font enables proper display of a character encrypted document or text for human reading the display, computer logic, e.g., search engines, will not make sense of the electronic document file—because such other computer logic will not use the matching encrypted font needed to understand the document, it will simply use the encrypted character codes.

For computer logic to understand text encrypted in accordance with aspects of the present invention, a decryption module and decryption key(s) could be used to enable the computer logic to return the encrypted text back to original standard encoding. This decryption module and decryption key(s) could be selectively given to entities or users for whom typical document searching and indexing is desired for one or more documents from an electronic document source, e.g., an electronic publishing system.

In accordance with one aspect of the present invention, provided is a method of encrypting text in electronic content carried out by a computer having one or more processors executing computer program code stored in at least one non-transitory storage device. The method comprises accessing electronic text from the at least one storage device; generating a character encrypted electronic text using a non-standard text encoding scheme to electronically reassign character codes of the electronic text; generating a matching character encrypted font configured to enable an output device to display the character encrypted electronic text in unencrypted form without decrypting the character encrypted text.

The method can further comprise generating matching character encryption and decryption keys configured to decrypt the character encrypted electronic text by reassigning character codes from the character encrypted electronic text to a standard text encoding scheme.

The method can further comprise executing an encryption application to generate the matching character encryption and decryption keys and matching character encrypted font, and executing an encryption module to character encrypt the electronic text using the matching character encryption and decryption keys.

The method can further comprise executing the encryption application at an encryption server in response to an encryption request by a content publishing system; electronically transmitting the matching character encryption and decryption keys and matching character encrypted font to the content publishing system; and executing the encryption module at the content publishing system to character encrypt the electronic text.

The method can further comprise downloading the character encrypted electronic text and matching encrypted font from the content publishing system to a remote computer.

The method can further comprise downloading the character encrypted electronic text and the matching character encryption and decryption keys from the content publishing system to a remote computer.

In such a case, the remote computer can be a search engine system. The method can further comprise decrypting the character encrypted electronic text to regenerate the electronic text with standard character encoding by the search engine system; and at least one of searching and indexing the regenerated electronic text by the search engine system.

The method can further comprise executing the encryption application at an encryption server in response to an encryption request by a content publishing system; executing the encryption module at the encryption server to character encrypt the electronic text; and electronically transmitting the character encrypted electronic text, matching character encryption and decryption keys, and matching character encrypted font to the content publishing system.

The method can further comprise downloading the character encrypted electronic text and matching encrypted font from the content publishing system to a remote computer.

The method can further comprise downloading the character encrypted electronic text and the matching character encryption and decryption keys from the content publishing system to a remote computer.

In such a case, the remote computer can be a search engine system. The method can further comprise decrypting the character encrypted electronic text to regenerate the electronic text with standard character encoding by the search engine system; and at least one of searching and indexing the regenerated electronic text by the search engine system.

The method can further comprise executing the encryption application acting as an encryption injection system. In such a case, the method can include generating the character encrypted electronic text and matching character encrypted font upon a user device requesting the electronic text and downloading the character encrypted electronic text and matching character encrypted font to the user device.

Accessing electronic text from the at least one storage device can be done in response to an electronic request for the electronic text.

The method can further comprise generating a new character encrypted text, new matching character encryption and decryption keys, and a new matching character encrypted font for subsequent requests for the electronic text.

The method can further comprise generating a new set of matching character encryption and decryption keys and matching character encryption font when the electronic text is requested to be viewed. As such, the encryption scheme can be changed in real-time, e.g., each time requested, randomly, or in accordance with some other programmed scheme.

The electronic text can include a plurality of text sections. In such a case, the method can further comprise character encrypting at least two of the text sections by reassigning character codes of different electronic text sections using different non-standard text encoding schemes for each of the different text sections.

The method can further comprise generating different matching character encryption and decryption keys for different character encrypted text sections, the different matching character encryption and decryption keys configured to decrypt a corresponding character encrypted text section by reassigning character codes from the corresponding character encrypted electronic text section to a standard text encoding scheme.

The method can further comprise generating different matching character encrypted fonts for different character encrypted text sections, the different matching character encrypted font configured to enable the output device to display a corresponding character encrypted text section in unencrypted form without decrypting the corresponding character encrypted text section.

The different matching character encrypted fonts can have different typefaces to show different glyphs.

The matching character encrypted font can be located on a remote computer.

In such a case, the method can further comprise generating the character encrypted text with an embedded electronic link reference to the matching character encrypted font at the remote computer.

The method can further comprise receiving an electronic request for the electronic text from a user device comprising the output device; in response to the electronic request, downloading the matching character encrypted font to the user device from the remote computer using the embedded electronic link reference; and displaying the character encrypted electronic text via the output device in unencrypted form without decrypting the character encrypted text.

The downloaded matching character encrypted font can be a transient matching character encrypted font. In such a case, the method can comprise deleting the transient matching character encrypted font at the user device upon closing a computer application used to display the character encrypted electronic text in unencrypted form.

The method can further comprise masking the embedded electronic link reference to the matching character encrypted font at the remote location.

The character encrypted text can include a text string, and the method can further include presenting the character encrypted text on a user device in unencrypted form without decrypting the character encrypted text; receiving user text entered via the user device; and enabling a next electronic action if the user entered text matches the presented unencrypted text.

The next electronic action can be electronically accessing a secure account.

The next electronic action can be electronically creating a secure account.

In accordance with another aspect of the present invention, provided is a computer program product stored in at least one storage device and executable by at least one processor to perform a method of encrypting text in electronic content. The method comprise accessing electronic text from the at least one storage device; generating a character encrypted electronic text using a non-standard text encoding scheme to electronically reassign character codes of the electronic text; and generating a matching character encrypted font configured to enable an output device to display the character encrypted electronic text in unencrypted form without decrypting the character encrypted text.

In accordance with yet another aspect of the invention, provided is a character encryption system. The system comprises at least one storage device including an electronic text; an encryption application executables by at least one processor to generate matching character encryption and decryption keys and a matching character encrypted font; and an encryption module executable by at least one processor to character encrypt the electronic text using the matching character encryption and decryption keys. Using the matching character encrypted font, the character encrypted electronic text can be displayed at an output device in unencrypted form without decrypting the character encrypted text.

In accordance with yet another aspect of the present invention, provided is a character encrypting user input device. The user input device includes one or more processors configured to execute computer program code stored in at least one non-transitory storage device; at least one user input mechanism; and an encryption module executable by the one or more processors to character encrypt electronic textual inputs received via the at least one user input mechanism, using a non-standard text encoding scheme to electronically reassign character codes of the received electronic textual inputs.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A is a representation of standard ASCII character encoding, in accordance with the prior art;

FIG. 1B is a block diagram of a computer demonstrating how a computer application applies standard fonts to display a document, in accordance with the prior art;

FIGS. 1C and 1D show various types of CAPTCHA, in accordance with the prior art;

FIG. 2 provides a high level block diagram representation of a computer system running a typical computer application used in conjunction with a character encryption system, in accordance with aspects of the invention;

FIG. 3 is a high level block diagram representation of computer system used to process a character encrypted electronic document, in accordance with aspects of the invention;

FIG. 4 is a an embodiment of an electronic document that uses more than one set of character encoding, or encoding schemes, in accordance with aspects of the invention;

FIG. 5 shows electronic document as it is displayed by a computer when the computer (or application) uses corresponding matching encrypted fonts, as well as standard fonts for the unencrypted section of the text, in accordance with aspects of the invention;

FIG. 6A shows an embodiment of matching encrypted fonts that can be provided remotely and served in real-time when a document is requested, in accordance with aspects of the invention;

FIG. 6B shows an embodiment of matching encrypted fonts that can be provided remotely and served in real-time when a document with a masked matching font link, in accordance with aspects of the invention;

FIG. 7 shows a basic flow diagram of an embodiment of character encryption/decryption key pair generation, distribution, and use, in accordance with aspects of the invention;

FIG. 8 provides an embodiment of a system that uses a character encryption system and method, in accordance with the present invention;

FIG. 9 provides another embodiment of a system that uses a character encryption system and method, in accordance with the present invention;

FIG. 10 provides another embodiment of a system that uses a character encryption system and method, in accordance with the present invention;

FIG. 11 provides another embodiment of a system that uses a character encryption system and method, in accordance with the present invention;

FIG. 12 shows an embodiment of a character encryption application, server, or system acting as an encryption injection system, in accordance with the present invention;

FIG. 13 shows one embodiment of a text input mechanism in accordance with the present invention; and

FIG. 14 shows another embodiment of a text input mechanism in accordance with the present invention.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

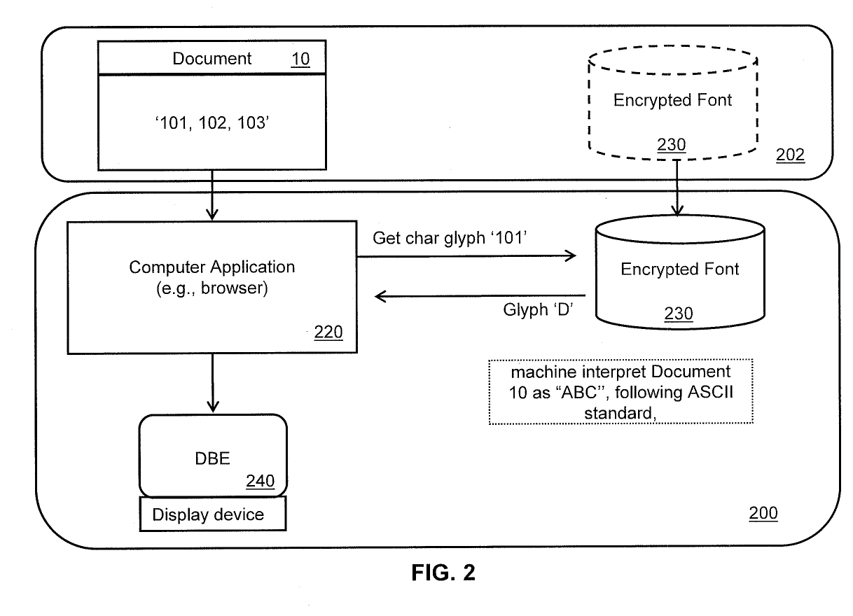

FIG. 2 provides a high level block diagram representation of a computer system 200 running a typical computer application 220. As examples, the computer system could be a Windows or MAC computer, a cell phone, a tablet, or a personal digital assistant. The computer system 200 could be running a browser, word processing application, or the like, as examples, used to process and open an electronic document 10, which could be downloaded, received, or accessed from another system, server, subsystem, or application 202. Here, electronic document 10 has been downloaded via a browser and does not have character encrypted text. Also, an encrypted font 230 has been downloaded with reassigned character codes.

Table 1 above shows a representation of a portion of a standard font table, with standard glyph index pointers. Table 2 below shows an embodiment of a representation of a portion of an encrypted font table, with the glyph index pointers reassigned, in a non-standard manner.

TABLE 2
Encrypted Font

| Character | Glyphs Index | Character |
|---|---|---|
| encoding | Pointer | Glyphs |
| 101 | 200 | ‘D’ |
| 102 | 201 | ‘E’ |
| 103 | 202 | ‘B’ |
| 104 | 203 | ‘A’ |
| 105 | 204 | ‘C’ |

By reassigning the glyph index pointers, the font character points to glyphs that are different from those of the standard font, e.g., compare Tables 1 and 2. For example, the character code 101 in Table 2 points to character glyph “D,” instead of “A” as in Table 1. Character code 102 points to character glyph “E,” character code 103 points to character glyph “B,” and so on. So when a system or computer program requests a glyph for character encoding 101, the system or program will receive the character glyph “D.”

Since electronic document 10 has standard font encoding, the computer logic interprets “101, 102, 103” as meaning “ABC.” This is a proper interpretation of electronic document 10. But because the computer application uses the encrypted font 230 to interpret the character encoding of the electronic document 10, the human user of display 240 sees the document differently—not properly. The computer application 220 seeking to open and display document 10 requests glyphs as it normally would from a font. However, encrypted font 230 is used, e.g., as shown in Table 2, e.g., because it was provided with document 10. Therefore, when application 220 requests the glyph for character codes 101, 102, and 103, glyphs “DBE” will be displayed at display 240, rather than “ABC.” “ABC,” i.e., the character string written by the document's author, would not be displayed because the encrypted font 230 was used to process document 10. In this way, encrypted font 230 causes the original content of document 10 to appear encrypted to a reader of display 240.

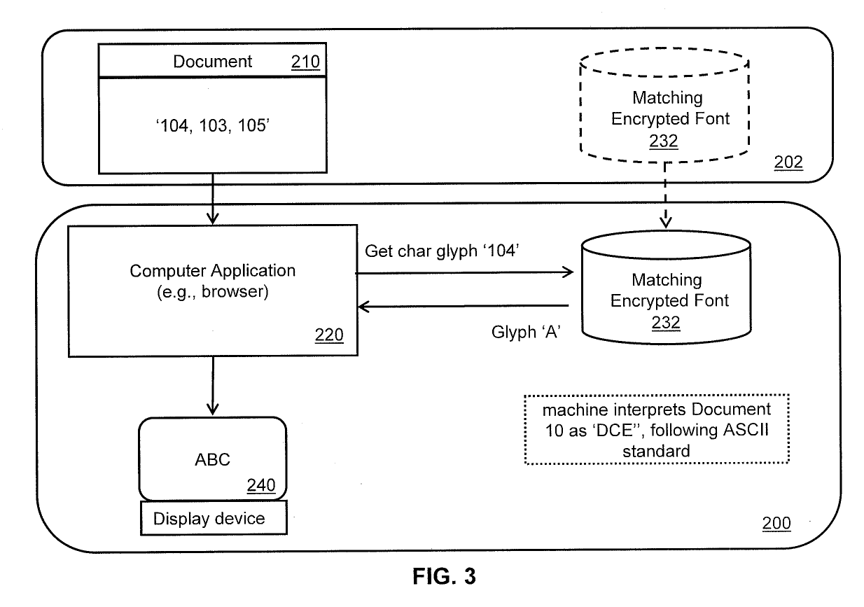

Like FIG. 2, FIG. 3 provides a high level block diagram representation of computer system 200, as described above, used to process an electronic document 210. Electronic document 210 has been character encrypted, i.e., at the character encoding level, thereby requiring a matching encrypted font 232 to determine the proper meaning of the character encrypted text. For example, the character encryption takes the form of reassigning font table character codes to characters that are different from those assignments made in a standard font table. That is, using a matching encrypted font, e.g., encrypted font 232 partially shown in Table 2, the system 200 will display “ABC”’ glyphs correctly on display 240, as in FIG. 3.

Computer applications that do not have access to the matching encrypted font 232, like Internet search engines, will interpret the content of electronic document 210 using standard encoding logic. Therefore, the computer logic will interpret the character codes ‘104, 103, 105’ in the encrypted document 210 as characters “DCE,” by applying standard font and character encoding. Such applications cannot properly interpret the characters as “ABC,” and do not know the electronic document 210 has been encrypted at the character level. Such applications will not generate errors when processing an encrypted document—but will not make any sense of the encrypted document's content—which will be perceived as a collection of characters without any particular meaning.

In the preferred embodiment, the matching encrypted font 232 is provided with the character encrypted electronic document 210, but as a separate file. Only an application having the matching encrypted font 232 can display the correct characters. And copying the character encrypted electronic document 210 would be pointless without also being provided the matching encrypted font 232. For example, only permitted downloads or copies of electronic document 210 could be provided with the matching encrypted font 232. Unauthorized copies would not get the matching encrypted font 232, so would not be able to make sense of the content of the character encrypted document 210. For example, a computer would display electronic document 210 as scrambled characters, cut and paste operations would be of scrambled characters, and printouts would also be scrambled.

Thus, in FIG. 3, computer application 220 uses matching encrypted font 232 to display electronic document 210, so the content of the electronic document 210 is displayed correctly, as “ABC.” Thus, the human user can read the content perfectly, but the computer logic still cannot make sense of the document's content because the content continues to appear as scrambled characters to the computer logic. This is because a human ‘sees’ the resulting glyphs in the display 240 and understands the character by glyphs (shapes), not by the underlying character encoding. But the computer “sees” the document according to the character encoding. As a result, beyond displaying electronic document 210, operations performed by the computer 200 will be futile because the encrypted character encoding will have no meaning, and will not match the content displayed. The computer applications use standard encoding to store necessary information and will not be able to make the necessary matching to make the document understandable to the computer. The computer application does not “see” the displayed glyphs (shapes), so it cannot understand document 210—even though the human user can see and understand the glyph shapes of ‘ABC,’ regardless of the underlying character codes—as long as the matching encrypted font 232 is supplied.

By encrypting electronic document 210 at the character code level and controlling distribution and use of the matching encrypted font 232, the present invention can provide an electronic document security solution where the electronic document has a human readable display, while computer applications find the same document to be without reasonable interpretation.

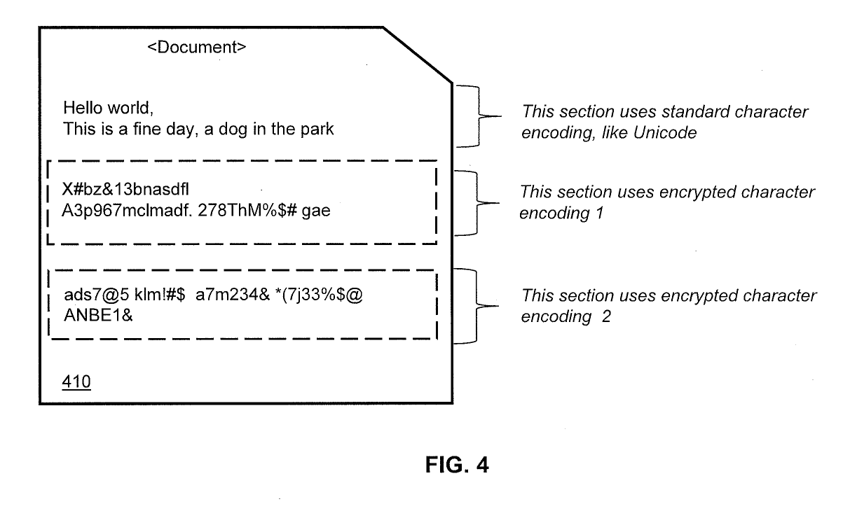

In some embodiments, different sections of an electronic document can have different character encoding. FIG. 4 shows an embodiment of an electronic document 410 that uses more than one set of character encoding, or encoding schemes. The present invention, because it processes documents at the character level, can divide document 410 into many sections and each section can have its own character encoding scheme.

In FIG. 4, a first section of the electronic document 410 uses a standard font encoding—and is understandable to human and computer. A second section of the document 410 uses a first encrypted character encoding (or encrypted font) and a third section of the document uses a second encrypted character encoding (or encrypted font). Document 410 would be displayed and interpreted by a computer just as shown—if only a standard font were used. Using a plurality of differently character encoded schemes, will require a plurality of matching encrypted fonts, and the complexity of trying to perform unauthorized operations on the electronic document 410 becomes very difficult for a computer.

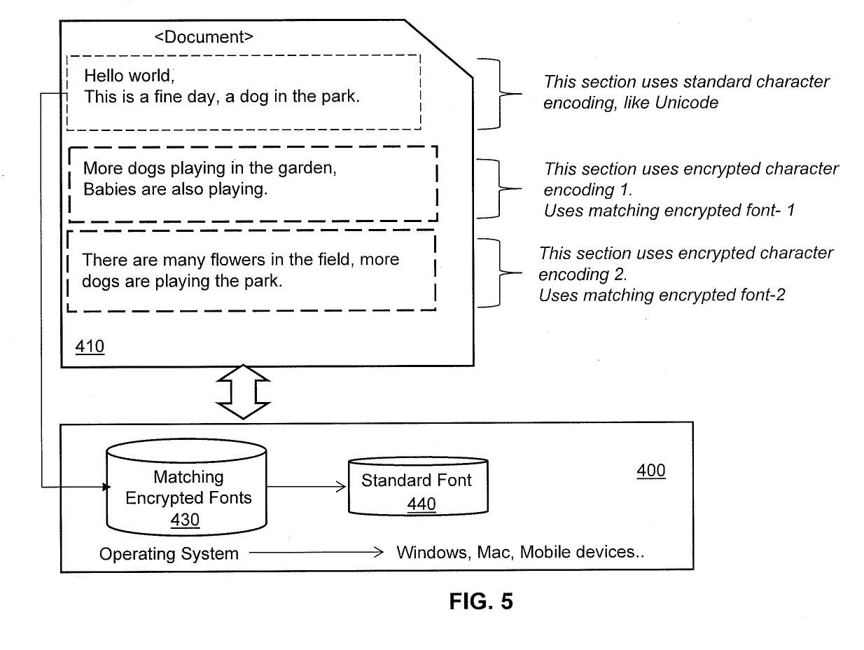

FIG. 5 shows electronic document 410 as it is displayed by the computer 400 when the computer (or application) 400 uses corresponding matching encrypted fonts 430, as well as standard fonts 440 for the unencrypted section of the text. By providing matching encrypted fonts 430 with electronic document 410, where each section of text is linked to a corresponding matching encrypted font, the document is properly displayed and a human can read the resulting document on a display of computer 400. However, computer 400 cannot understand the content of electronic document 410, as previously described, even though a user can read it on the display (as shown). Because, the encrypted sections of the document are nothing more than a meaningless collection of characters to the computer logic. Therefore, one can choose to selectively encrypt portions of an electronic document—making only those encrypted sections unintelligible to the computer's applications.

For example, an Abstract of a document could be encoded using standard character encoding, but the rest could have character encryption as described herein. Electronic document 410 could be made available by a publishing system via the Web. Therefore, anyone could view the Abstract, and search engines could find and index the document based thereon. But the publishing system could also only provide the matching encrypted fonts 430 for the encrypted portions of electronic document 410 if a user pays a fee.

In various embodiments, therefore, the matching encrypted fonts can be located remotely, e.g., on a publishing system or server, and downloaded as the document is requested by a user at computer 400. The font data may exist only in a transient state in the displaying application, like Internet browsers. The matching encrypted fonts can be removed from local devices when the displaying application is terminated, like the image files in Web pages. As a result, retained copies of an electronic document having encrypted text will be subsequently unintelligible to the human user, as well as the computer logic. For example, matching encrypted fonts can be made such that they are not permanently stored at the local devices. In this way, unauthorized copying of character encrypted text and documents will be difficult, since to read the character encrypted text or document one must have the matching encrypted fonts.

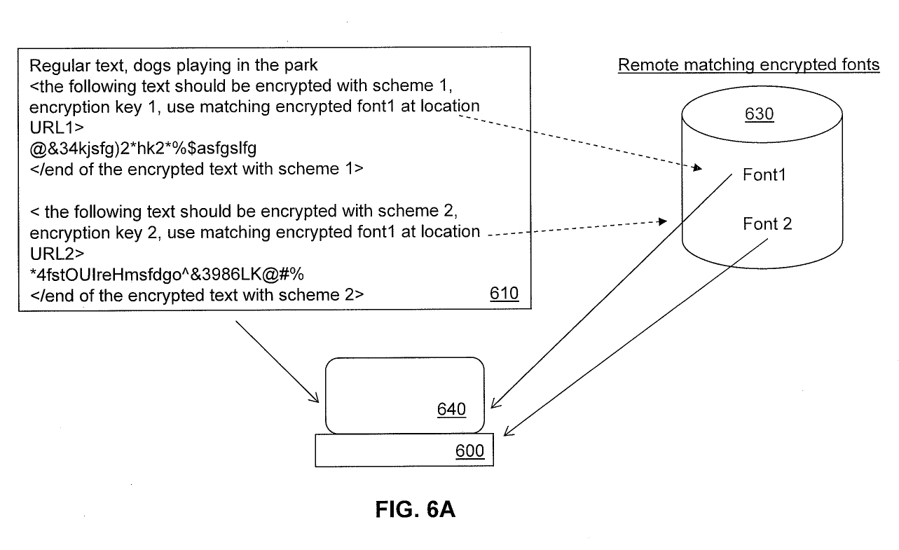

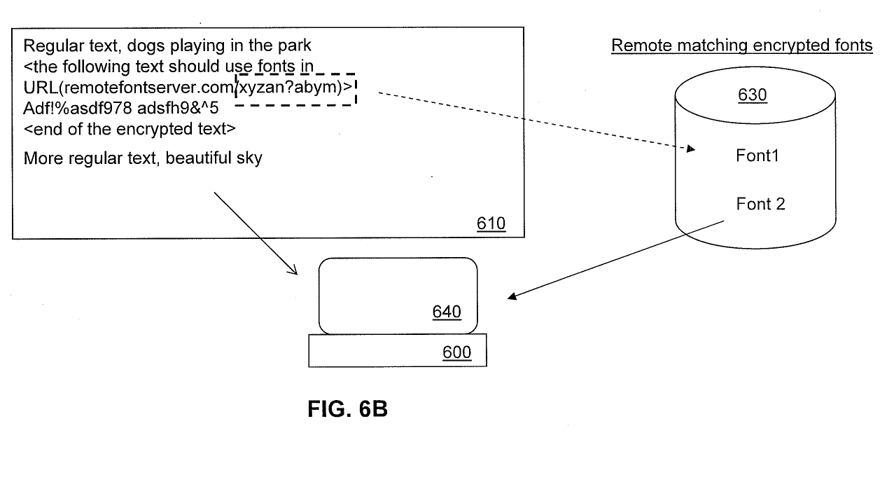

As is shown in FIG. 6A, matching encrypted fonts 630 can be provided remotely and served in real-time when a document 610 is requested, e.g., from a server, database, and so on. Document 610 can have encrypted sections marked to refer to each matching encrypted font's remote location, e.g., with a URL. When document 610 is requested or viewed by applications, like Internet browsers, by a user with a local device 600 like a personal computer, cell phone, or the like, the matching encrypted fonts 630 can be downloaded in real-time to the local device 600 so the user will see the correct text. The matching encrypted fonts 630 can be matched using the references in the document 610.

In some embodiments, the matching encrypted font links can be “masked,” as shown in the example of FIG. 6B. In FIG. 6B the matching font link is shown in the box with dashed lines. Masking the matching encrypted font links can make unauthorized copying of the character encrypted document 610 difficult or not useful, because the links to the matching encrypted fonts 630 are encrypted. Thus, there is no way to determine those links directly from the electronic document 610. Without the matching encrypted fonts 630, the encrypted document 610 will be unintelligible to a computer or human user. The masking of the matching font links can be implemented in real-time and masked font links be changed each time the electronic document 610 is requested. This can further enhance the security of the document.

In some embodiments, an electronic document can be encrypted at the character level and the matching encrypted font 630 can be generated in real-time, so each time the electronic document 610 is requested or viewed it can have different encrypted encoding and different matching encrypted font 630. If one wants to copy the content by grabbing the encrypted text encoding, the matching fonts of that instance must be also obtained, which can require the proper links to the matching encrypted font. In this way, the difficulty of unauthorized copying or unauthorized interpretation is increased. At the same time, this does not affect human reading of the content on a display, since the human can still see the correct glyphs, e.g., “ABC,” which is not disrupted by the underlying character encoding changes.

In some embodiments, it may be desirable to provide the ability to “decrypt” a character encrypted document—which means reassigning of the encrypted character codes within the electronic document to the standard character codes from the standard font. As a result, a matching encrypted font would no longer be needed to properly display the “decrypted document,” and computer logic and applications would be able to understand the content of the decrypted document, such as for searching and indexing.

In some embodiments, character encryption and character decryption “keys,” similar to the general concept of RSA public/private key pairs, can be generated, as “matching character encryption and decryption keys.” But the matching character encryption and decryption “keys” are different from typical RSA type public/private key pairs, which have no relationship to the character level encoding described herein—or matching encrypted fonts. In particular, a “character encryption key” is a computer program code that implements an algorithm or scheme for reassigning character level codes so they do not point to the same glyphs they would in a standard font encoding. And a “character decryption key” is a computer program code that implements an algorithm or scheme for reassigning character level codes in a character encrypted document back to a standard encoding.

A character decryption key can decrypt text encrypted by its corresponding encryption key. In this sense, the encryption key and decryption key can be said to be “matching.” If an entity is authorized to read, distribute, and/or index the electronic document, then the encryption and decryption keys, along with the decryption logic, will be given to the entity. The authorized entity can use decryption logic with the encryption and decryption keys to decrypt the encrypted document character code and map the character codes correctly. For example, an Internet search engine with proper encryption and decryption keys, and the decryption scheme, can transform the character encrypted electronic document into an electronic document having standard character encoding and then correctly index and search the electronic document.

Below in as example of, first, a flow of character encryption, and the products thereof and, second, a flow of character decryption, and the products thereof:

Character Codes:

| Encryption | Products |
|---|---|
| ‘101, 102, 103’ => | (Encryption Key 1 + Decryption Key 1) + Encryp- |
| | tion Text (codes ‘89, 701, 855’ in place of ‘101, |
| | 102, 103’) |
| ‘89, 701, 855’ => | (Encryption Key 1 + Decryption Key 1) + Matching |
| | Encrypted Fonts, Encrypted character codes mapped |
| | back to standard character codes ‘101, 102, 103’ |

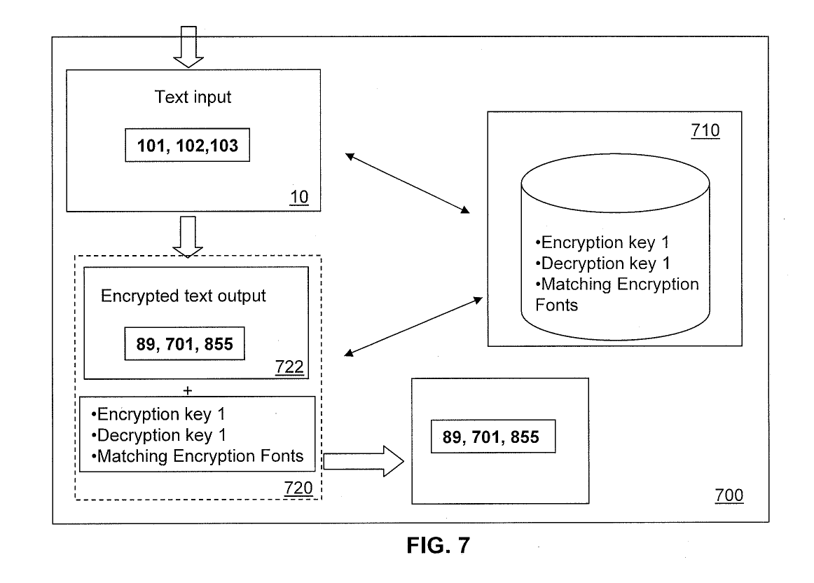

FIG. 7 shows a basic flow diagram of an embodiment of character encryption/decryption key pair generation, distribution, and use. Character encryption key generation, matching encrypted font generation, and character encrypted document generation can be accomplished by a character encryption system 700. In FIG. 7, encryption key generation and storage is done by a character encryption application 710, and the bidirectional nature of encryption and decryption is shown. The encryption and decryption keys can be stored in a character encryption key database. The encryption and decryption keys can then be used by a text encryption module 720 to encrypt the text of electronic document 10.

The encryption and decryption keys and matching fonts can be distributed with the encrypted text 722, as will be described in the examples below.

To maintain the layout and display, necessary control character codes like Space (ASCII code), Form feed (ASCII code 12), End of line (ASCII code 3) and so on need not be encrypted to keep the function and form of the text intact, in the preferred embodiment.

The encryption application 710 can use different fonts with different typefaces, glyph designs, so even if an unauthorized application tries to use Optical Character Recognition, a technique to translate scanned images of text into machine-encoded text, will have difficulty. This is because the glyphs (images) will change as different fonts are used. When a high number of different fonts with distinct design or glyph shapes are used, this will make OCR difficult to achieve accuracy and efficiency.

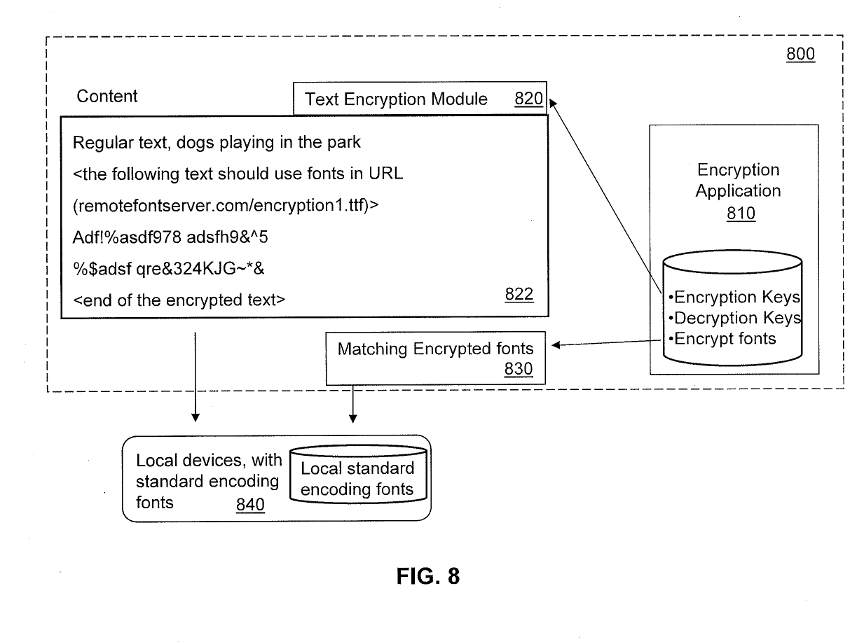

FIG. 8 provides an embodiment of a system that uses a character encryption system and method in accordance with the present invention. In this embodiment, a publishing system 800 includes a character encryption application (or module) 810 and a text encryption module 820. In this embodiment, therefore, the publishing system 800 and character encryption application 810 are local to each other, e.g., in the same system. The character encryption application 810 will generate encrypted fonts and character encryption/decryption key pairs. Text encryption module 820 will encrypt the text of an electronic document by using the encryption key to reassign character codes.

The character encryption performed by character encryption module 810 rearranges the character encoding from a standard ASCII or Unicode font into a character encrypted font, as shown with respect to Table 2 above. The character encryption key produced by character encryption application 810 provides the algorithm for the reassignments. The character decryption key provides the algorithm for interpreting the reassigned character encoding in a manner that enables the electronic document to be transformed into an electronic document having standard character encoding. The matching encrypted font enables a user to view the correct character encrypted text, even though the character encoding itself remains in the reassigned (encrypted) state.

Publishing system 800 can be configured to publish electronic content and documents online in HTML format, in some embodiments. In various embodiments, the electronic documents can be published in different formats and network protocols.

In FIG. 8, publishing system 800 has an exemplary content text 822 illustrated, which is intended to be published online. Electronic document 822 can be published in different formats and on networks, like the Internet. For example, the character encrypted document 822 can be published to another site with the encryption/decryption key pair, enabling that site to generate a standard font document from the character encrypted electronic document. The standard font document could be searched and indexed, as examples, without problem. The character encrypted document 822 could also be published with the matching encrypted font 830, which would enable proper display of character encrypted electronic document 822, but not searching or indexing, as examples.

Therefore, a publisher of character encrypted electronic document 822, can ensure that, for example, document text cannot be copied easily and cannot be indexed by search engines. Additionally, or alternative, the publisher might want to verify the interaction with the document 822, and the site hosting it, is with a real human and not with an automate program. Character encrypted document 822 has instructions identifying the text sections that need to be encrypted. The text sections can be variables to be fetched in real-time, e.g., like web pages.

In this embodiment, a section of character encrypted document 822 to be encrypted can have a starting mark in the document to represent a start of encryption and the ending mark to represent an ending of encryption, as is shown in FIG. 8.

Each encryption section will be character encrypted with the appropriate character encryption scheme. Each time the text is encrypted the resulting character encrypted text will be different, with corresponding encryption and decryption keys and matching encrypted fonts generated. The encryption/decryption schemes can be provided to the publisher system 800 beforehand, or can be later obtained or generated from the encryption application 810, e.g., in real-time upon request for the character encrypted electronic document 822.

In the present embodiment, the character encryption application 810 will take the text input, parse it and use an encryption scheme to rearrange the text encoding in the sections that are marked to be encrypted. The matching character encryption/decryption keys and the matching encrypted fonts will be stored. The encryption/decryption keys can be used by an authorized entity or entities to interpret the character encrypted document properly by its applications, like searching engines. The encryption application 810 can replace the regular text encoding with encrypted text encoding and it will then insert the matching encrypted fonts' location (URL, Uniform Resource Locator) in the resulting character encrypted electronic document 822. This process can be repeated until all text sections to be character encrypted are processed.

Additionally, or alternative, the process can be repeated the next time a user requests the document to read. The character encryption/decryption keys and matching encrypted fonts can be changed from time to time, either at the request of the publishing system or an internal process of encryption application 810. This will increase the number of encryptions, making it more difficult to decrypt character encrypted electronic content or documents.

When a reader accesses the character encrypted document 822, e.g., Internet web pages, the pages will contain the encrypted text with the URL pointing to the matching character encrypted fonts. The browsing application, like an Internet browser, will retrieve the matching encrypted fonts to display the encrypted sections of the document on a display (e.g., see FIG. 6B).

Also, when an unauthorized application, like a spamming application, attempts to harvest an email address from an electronic document, it will look for text having a pattern with an email address format, e.g., xxx@xxx.xxx. It will retrieve the content of the web page, but if the content is character encrypted the email address will not be in the pattern the spamming application is programmed to look for—so it will not be recognized, or otherwise retrieves the encrypted email address which is of no use because it is not a link to a matching character encrypted font.

Also, when an unauthorized search engine trying to index keywords and content in a character encrypted electronic document, the search engine will not be able to properly index the content since the text is character encrypted. Similarly a surveillance system trying to find keywords on a web site that includes the character encrypted electronic document, the surveillance system will not be able to match the keywords because the text is encrypted.

The content publisher can give the matching character encryption and decryption keys to authorized entities, for example search engines or search engine sites. The search engines will scan the web page and see the encoding keys in the character encrypted document; it will then search character decryption keys, which it may have stored, to see if there is a matching pair. When a matching character decryption key is found, then the encrypted text will be decrypted with the matching decryption key. Entities without the matching character decryption key will not be able to decrypt the content correctly. Various embodiments can use the Internet protocol and HTML as the document format.

Distributed Character Encryption System

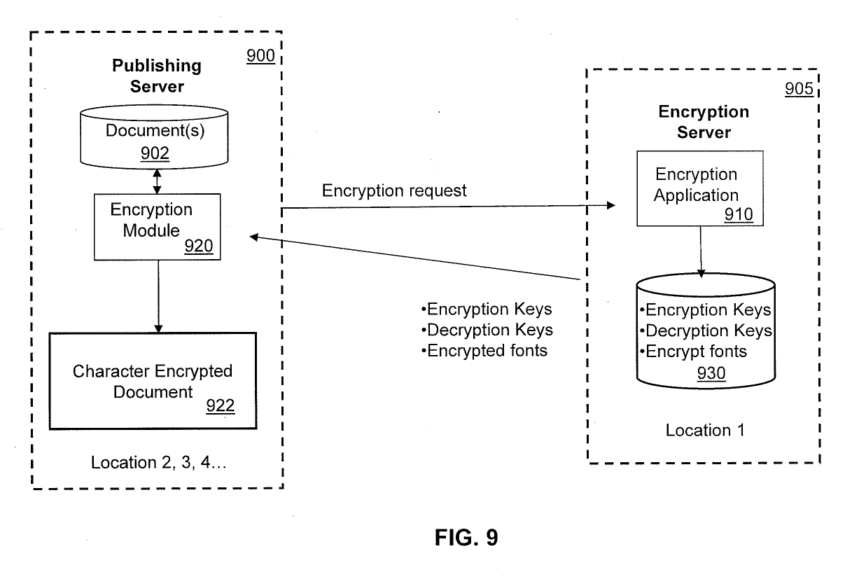

FIG. 9 provides another embodiment of a system that uses a character encryption system and method in accordance with the present invention, which is an alternative to that shown in FIG. 8. In this embodiment, a publishing system (or server) 900 and character encryption system (or server) 905 are at different locations—i.e., remote to each other. A character encryption application 910 hosted by character encryption system 905 in a remote location can act as an online application (or “Software as Services”) accessible via a network, e.g., the Internet or a private network. As an example, publishing system 900 can send a character encryption request to character encryption server 905 via a network (e.g., Internet). The character encryption server 905, e.g., acting as an application server, generates character encryption/decryptions keys, and the character encrypted fonts, which it can at least initially store locally in database 930. Upon receiving the character encryption/decryption keys, an encryption module 920 in the publishing system 900 can character encrypt the text of an electronic document 902 to create a character encrypted document 922. Encryption module 920 can also refer the encrypted fonts accordingly with respect to character encrypted documents, as matching encrypted fonts. The matching encrypted fonts can be hosted in local or remote location.

Publishing system 900 can be configured to publish content and documents online in HTML format. The documents can be published in different formats and network protocols. Encryption module 920 allows the publisher to have character encrypted documents 922 where the text cannot be copied easily and cannot to be indexed by search engines, or the publisher may want to verify the interaction of the publishing system's Web site is with a real human and not with an automate program prior to making encrypted documents properly readable.

In this embodiment, character encryption server 905 is at location 1, as a character encryption service that can provide the character encryption services to different publishing systems 900 at locations 2, 3, 4, and so on. Each publishing system 900 can have a character encryption module 920 to character encrypt text in electronic documents 902. Encryption module 920 will receive the character encryption/decryption keys and the matching encrypted fonts supplied by the remotely located encryption server 905. To do this, the publishing system 900 will send an encryption request to the encryption server 905. The encryption server 905 can respond to the encryption request with an authentication the request, in embodiments where authentication is desired. If the authentication request is granted, the encryption server 905 can generate the character encryption/decryption keys, encrypted fonts, the location of the fonts, and send them to the publishing system 900. Encryption server 905 can send the location of the encrypted fonts if the publishing system 900 does not itself host the encrypted fonts.

The publishing system 900 will receive the character encryption/decryption keys, encrypted fonts, and the location of the encrypted fonts. The encryption module 920 at publishing system 900 will character encrypt the text with the supplied character encryption key(s) and, for each section of character encrypted text, include a reference in the encrypted document to the location of matching encrypted fonts for the encrypted text section.

Assuming publishing system 900 (or encryption module 920) stores the character encryption/decryption keys, it can then selectively provide them to an authorized entity to be used to character decrypt the character encrypted text. If the keys are stored elsewhere, the publishing system 900 (or encryption module 920) can store the character encryption/decryption keys locations and provide those locations or retrieve the character encryption/decryption keys from those locations as needed.

The process can be repeated each time a user requests a document 902 to read. The character encryption/decryption keys and encrypted fonts can be changed from time to time either by the request of the publishing system 900 or encryption application 910 internal processes. This can increase the number of encryptions, making it is more difficult to decrypt the document for unauthorized users or programs.

Distributed Character Encryption Systems With Publishing Server Does Not Encrypt Text

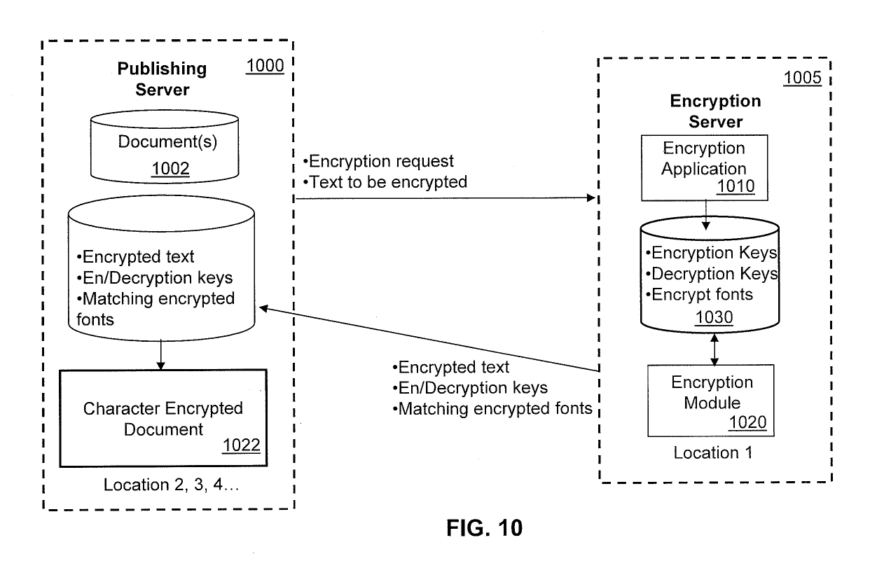

FIG. 10 provides another embodiment of a system that uses a character encryption system and method in accordance with the present invention, which is an alternative to that shown in FIGS. 8 and 9. In this embodiment, a distributed character encryption system 1005 provides character encryption services as online “Software As Services,” where a publishing system 1000 does not have an encryption module 1020. Publishing system 1000 can send text from an unencrypted document 1002 to the encryption server 1005 to be character encrypted; the remote encryption server will encrypt the received electronic text and generate character encryption/decryption keys and matching encrypted fonts, which can be stored in database 1030. The publishing system 1000 will receive the encrypted text and refer the matching encrypted fonts, which could reside remotely or locally.

In this embodiment, character encryption system 1005 will generate character encryption/decryption keys, generate encrypted fonts, and encrypt electronic text characters received from publishing system 1000.

In this embodiment, publishing system 1000 will receive the encrypted text, character encryption/decryption keys, and encrypted fonts, and will also point the encrypted text sections in an encrypted electronic document to matching encrypted fonts and periodically update the encryption/decryption keys and matching encrypted fonts.

Therefore, in FIG. 10, publishing system (or server) 1000 does not encrypt text. The publishing system 1000 will send the text to the encryption server to be encrypted. After authentication and receiving the text to be encrypted, the encryption system (or server) 1005 will send encrypted text, encryption and decryption keys and send or post the matching encrypted fonts to be referenced in the document. Publishing system 1000 can selectively provide encryption/decryption keys and the encrypted document 1022 to a system authorized to decrypt the character encrypted document 1022, e.g., for searching and indexing. Publishing system 1000 can also selectively provide the character encrypted document 1022 and matching encrypted fonts to a user computer for properly displaying the document, without decrypting it.

Publishing Server With Local Character Encryption System

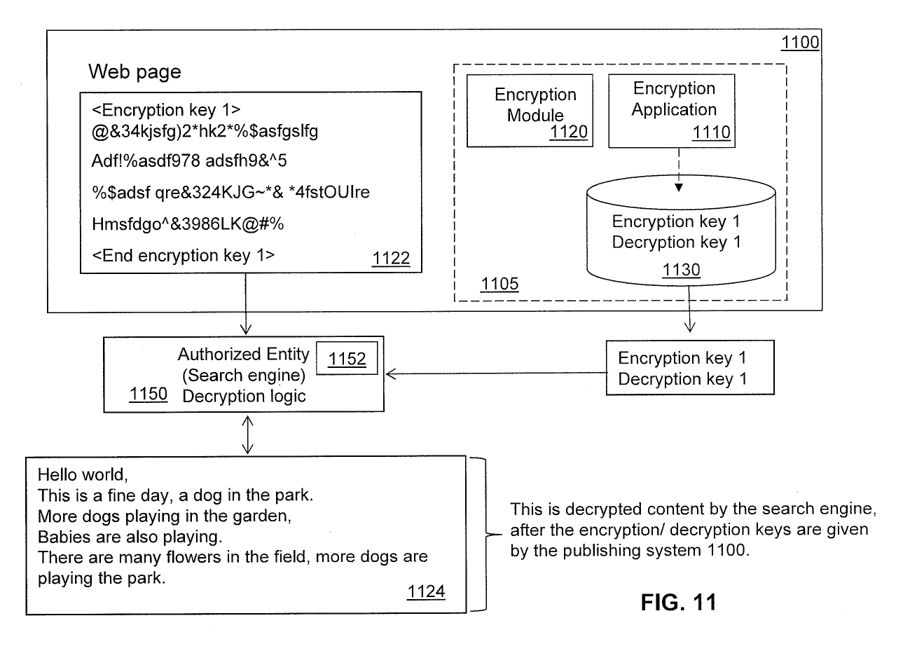

FIG. 11 provides another embodiment of a system that uses a character encryption system and method in accordance with the present invention. In this embodiment a publishing system 1100 includes an encryption system 1105, which can include an encryption application 1110, encryption module 1120, and storage 1130 for character encryption/decryption keys, and encrypted fonts. These functions of which have been described above.

In this embodiment, there is also and “authorized entity” 1150, such as search engine for example. Authorized entity 1150 is authorized by the publishing system 1100 to decrypt character encrypted documents published by the publishing system 1000. Therefore, authorized entity 1150 can be given decryption logic 1152 and, upon receiving the encryption/decryption keys, can interpret the content of character encrypted text correctly to produce and display, index, search, and so on unencrypted document 1124 from the character encrypted document 1122.

A search engine, and authorized entity 1150, can scan the web page 1122 and see the character encoding keys in the character encrypted document 1122; it will then search character decryption keys to determine if there is a match to form a matching pair. When a corresponding character decryption key is found, then the character encrypted text will be decrypted with the matching decryption key. Entities without the decryption key will not be able to decrypt the content of character encrypted electronic document 1122 correctly.

The implementation can use Internet protocol and HTML as the document format.

Character Encryption Injection System

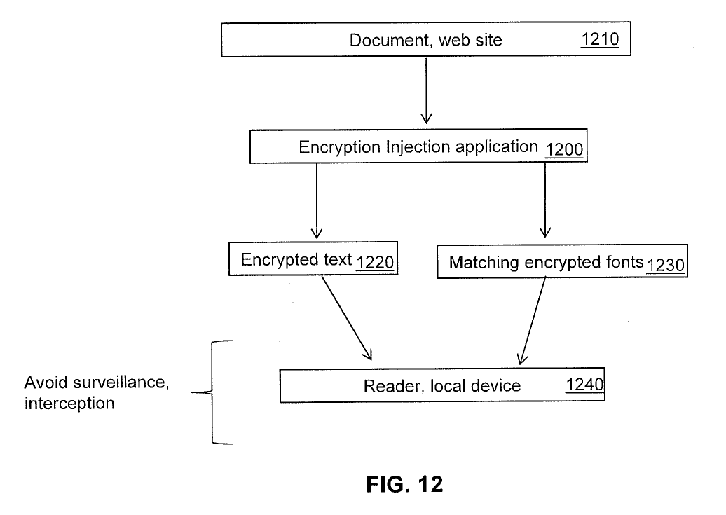

FIG. 12 shows an embodiment of a character encryption application, server, or system acting as an encryption injection system 1200. The regular document hosted in a network, like the Internet, can be directed to the character encryption injection system 1200 and the resulting encrypted text 1220 and matching encrypted fonts 1230 can be delivered to the recipient (reader) computer or device 1240.

More particularly, character encryption injection application 1200 can provide encryption in real-time for existing documents or web sites 1210 without the original document or web site needed to implement the encryption system. The original content of the electronic document 1210 will be passed through encryption injection application 1200, which will take the original document 1210, encrypt the text, and add a location reference to the matching encrypted fonts 1230. The resulting encrypted text 1220 is transmitted through a network, like the Internet, without being monitored and the requester at device 1240 can see on a display the encrypted document without problem using the matching character encrypted font 1230.

In this embodiment, as an example, a user at device 1240 can type in the URL of a regular web site, which is sent to the encryption injection system 1200, which can also be a web site. The encryption injection system 1200 can take the content of the URL, encrypt the content text 1220, generate the matching encryption fonts 1230 and add the reference or the location of the matching encryption font in the resulting web page. The user will be presented with the encrypted pages with matching fonts. When the user at device 1240 receives the text through a network, the content will be encrypted and avoid the surveillance or other interception, but the user will be able to read it.

This invention can be used in a variety of contexts that apply to network/Internet content publication protection. A web page can be encrypted by the scheme described above with character encryption changing in real-time to prevent unauthorized copying of the content. The unauthorized copying of the text with encrypted encoding without matching encryption fonts cannot be read while the content appears normal to human eyes. When the text is character encrypted, it is difficult to search, index, and modify.

Systems and methods in accordance with the invention can prevent unauthorized search engine indexing, spammer computers from collecting email addresses, and internet surveillance. However, by providing the character encryption/decryption keys to a system, like an authorized search engine, the right content can be provided in real-time. All these operations will not affect human reading the web page.

Systems and methods in accordance with the invention can provide a way to have only authorized entities, like an authorized search engine, governments etc. to properly search and index electronic content by providing the decryption scheme (encryption/decryption/encryption logic).

Human Readable, Computer-Unreadable Challenge-Response

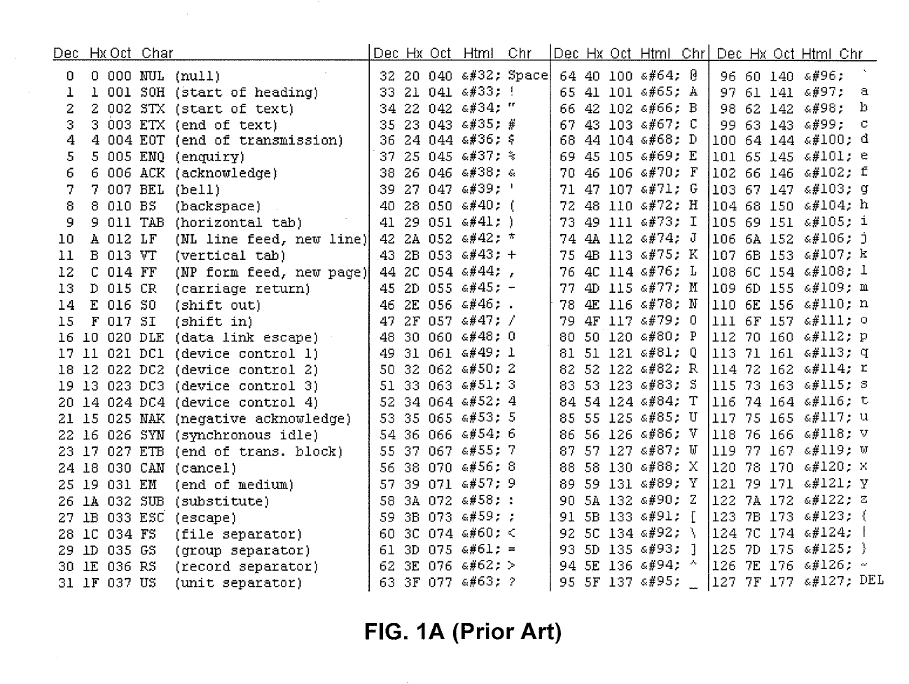

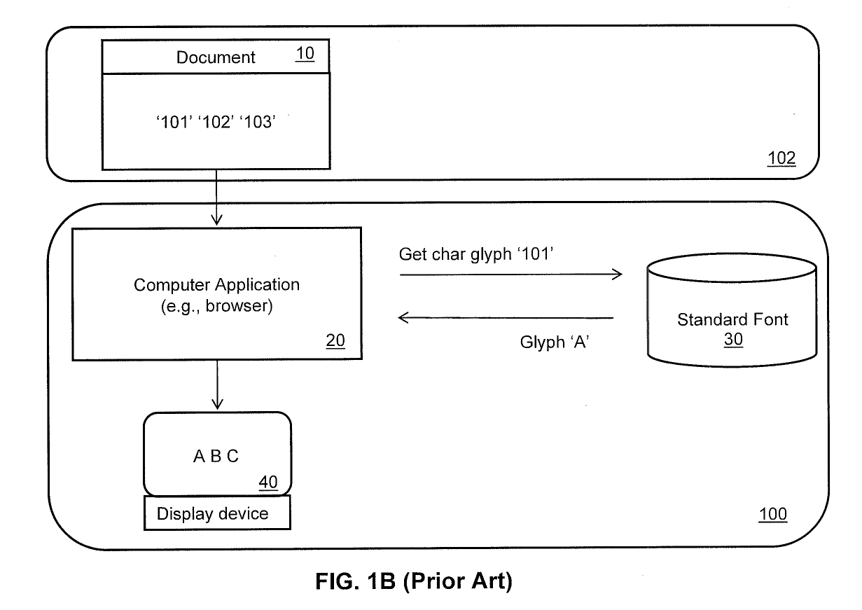

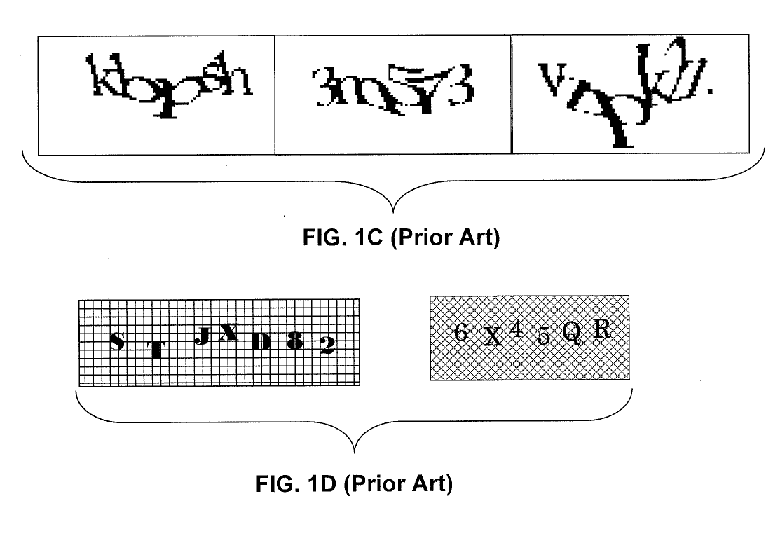

In accordance with various aspects of the invention, systems and methods can be provided to do human challenge and response, such as CAPTCHA. CAPTCHA is a type of challenge-response test used in computing as an attempt to ensure that the response is not generated by a computer or computer code, by replacing the difficult to read CAPTCHA graphic, like those in FIGS. 1C and 1D, with encrypted text and matching fonts. In various embodiments, a character encrypted text string with matching character encrypted font is display in computer application, for example a Web site or page. A human user can visually see correctly and read the encrypted text with matching encrypted fonts, as intended, while automated computer programs will get the underlying encrypted text codes, which will not make sense.

Therefore, systems and methods in accordance with the invention can be used in human verification from machine spamming, e.g., as an alternative to CAPTCHA and other such systems. That is, the invention provides a way for a computer with, for example, a Web browser interface, to distinguish human from machine interaction with a Web application.

For example, using CAPTCHA, when someone signs up for a Yahoo mail account or other account, or logs into a secure account or Web site, the user could be asked to type or input letters from a graphic image presented near the input field. The graphic image typically includes a text string in distorted form. With CAPTCHA, the graphic image does not include text characters, but is rather a graphic image, as sown in FIGS. 1C and 1D. Therefore, in CAPTCHA, individual letters in the graphic image have no meaning electronically individually or as a group.

As a result, an automated program will not be able to tell what the letters in the CAPTCHA graphic image, since such a graphic image does not have character encoding. But the problem with CAPTCHA is that sometimes human users have difficulty reading the graphic images correctly. Care is taken to make it difficult for an automated application that employs Optical Character Recognition (OCR), as an example, to read the CAPTCHA graphic, but at the same time, this makes it difficult for the human user, which can lead to human input errors or time wasting.

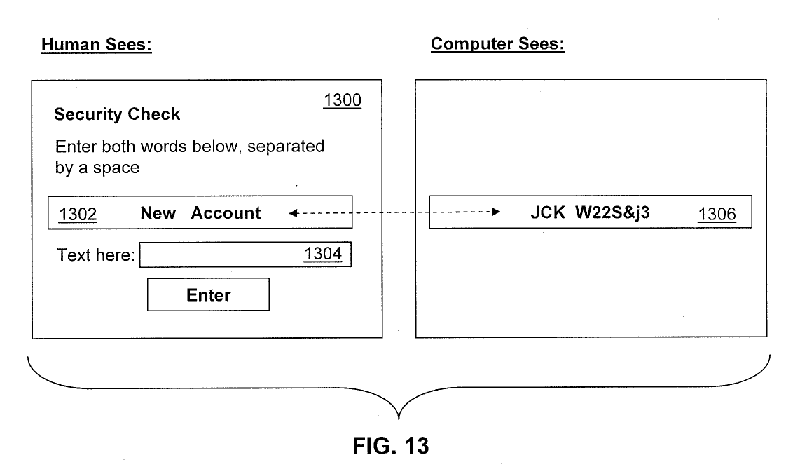

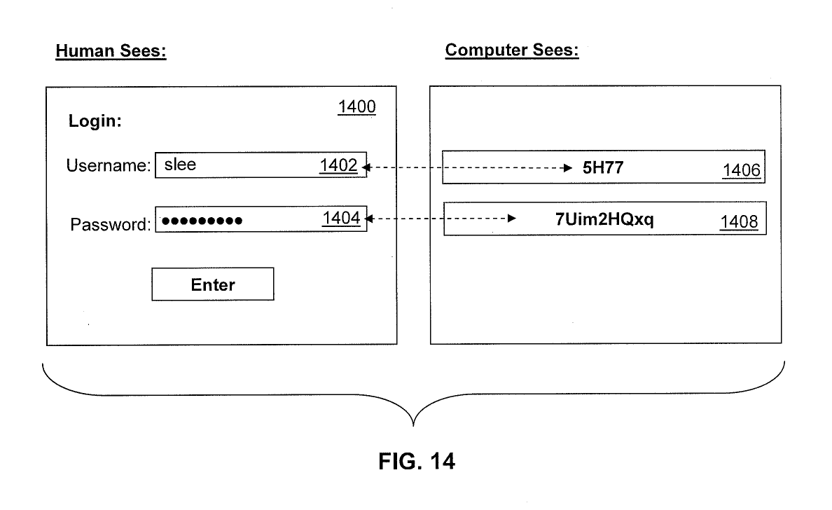

Referring to FIGS. 13 and 14, systems and methods that utilize the character encoding of the present invention provide a security alternative to CAPTCHA, or other such systems. By employing the present invention, a text string composed of encrypted characters with matching encrypted font can be displayed in the web page just like regular text and the human user will not have difficulty reading it correctly. But a computer application or code will see the character encrypted encoding and, it if attempts automated input, will input the wrong text string and it will be rejected.

For instance, in FIG. 13 a pop-up box 1300 is shown for a human user to establish a new account, in accordance with aspects of the present invention. Box 1302 shows two words presented by the computer for entry by the user in text input field 1304. Here, the words “New Account” are character encrypted at the file or electronic level, as discussed above. But since the computer has a matching character encrypted font, the words “New Account” are properly displayed to the user, without decrypting the underlying character encrypted text.

FIG. 13 also shows the character encrypted text (i.e., “JCK W22S&j3”) from the electronic file, in field 1306. The words are not visually distorted, and do not have to be—because knowledge of the character encrypted text is useless to threatening applications or code (e.g., worms, search engine bots, and so on).

As another example, FIG. 14 shows an example of a pop-up box 1400 a user can use to login to an application or account, in accordance with aspects of the present invention. Here, the human readable text entered by the user could be character encrypted upon input, using an appropriate character encryption key for reassigning the character codes. Thus, when a user enters “slee” in the Username field 1402, the computer sees the character encoded text “5H77,” in box 1406.” And when the user types in his password “eifFEI123,” which is displayed as “•••••••••” the computer sees and stores “7Uim2HQxq,” in box 1408.

In some embodiments, a keyboard, keypad, touchscreen, voice input, or other type of human user input device can include or work in conjunction with a character encryption application (or other program code) that character encrypts direct or indirect (e.g., voice to text) textual inputs as they occur. Such applications could use a character encryption key to accomplish such character encryption in real-time, which can have a corresponding or matching character decryption key. A matching font could also be generated. These could be updated and/or changed periodically, randomly, not at all, or otherwise—depending on the embodiment. These could be partly or fully embedded in the keyboard, keypad, touchscreen, voice input, or other type of human user input device, or partially or fully accessible from them.

In other embodiments, the present invention could also be used to establish an auction system for the right to search and index online content by automated applications like search engines. Entities could put this right up for bidding; the winner will be given the encryption/decryption keys in real-time, which will enable applications to automatically interpret the content properly. While unauthorized applications, like search engines, will not automatically search or index the content. Humans can read the content without any problem, regardless of the underlying character encrypted text encoding, as long as the matching encrypted fonts are provided properly.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A method of encrypting text in electronic content carried out by a computer having one or more processors executing computer program code stored in at least one non-transitory storage device, the method comprising:
accessing electronic text from the at least one storage device;
generating a character encrypted electronic text using a non-standard text encoding scheme to electronically reassign character codes of the electronic text; and
generating a matching character encrypted font configured to enable an output device to display the character encrypted electronic text in unencrypted form without decrypting the character encrypted text.

2. The method of claim 1, further comprising:
generating matching character encryption and decryption keys configured to decrypt the character encrypted electronic text by reassigning character codes from the character encrypted electronic text to a standard text encoding scheme.

3. The method of claim 2, further comprising:
executing an encryption application to generate the matching character encryption and decryption keys and matching character encrypted font; and
executing an encryption module to character encrypt the electronic text using the matching character encryption and decryption keys.

4. The method of claim 3, further comprising:
executing the encryption application at an encryption server in response to an encryption request by a content publishing system;
electronically transmitting the matching character encryption and decryption keys and matching character encrypted font to the content publishing system; and
executing the encryption module at the content publishing system to character encrypt the electronic text.

5. The method of claim 4, further comprising:
downloading the character encrypted electronic text and matching encrypted font from the content publishing system to a remote computer.

6. The method of claim 4, further comprising:
downloading the character encrypted electronic text and the matching character encryption and decryption keys from the content publishing system to a remote computer.

7. The method of claim 6, wherein the remote computer is a search engine system, the method further comprising:
decrypting the character encrypted electronic text to regenerate the electronic text with standard character encoding by the search engine system; and
at least one of searching and indexing the regenerated electronic text by the search engine system.

8. The method of claim 3, further comprising:
executing the encryption application at an encryption server in response to an encryption request by a content publishing system;
executing the encryption module at the encryption server to character encrypt the electronic text; and
electronically transmitting the character encrypted electronic text, matching character encryption and decryption keys, and matching character encrypted font to the content publishing system.

9. The method of claim 8, further comprising:
downloading the character encrypted electronic text and matching encrypted font from the content publishing system to a remote computer.

10. The method of claim 8, further comprising:
downloading the character encrypted electronic text and the matching character encryption and decryption keys from the content publishing system to a remote computer.

11. The method of claim 10, wherein the remote computer is a search engine system, the method further comprising:
decrypting the character encrypted electronic text to regenerate the electronic text with standard character encoding by the search engine system; and
at least one of searching and indexing the regenerated electronic text by the search engine system.

12. The method of claim 3, further comprising:
executing the encryption application acting as an encryption injection system, including:
generating the character encrypted electronic text and matching character encrypted font upon a user device requesting the electronic text; and
downloading the character encrypted electronic text and matching character encrypted font to the user device.

13. The method of claim 1, wherein accessing electronic text from the at least one storage device is done in response to an electronic request for the electronic text.

14. The method of claim 13, further comprising:
generating a new character encrypted text, new matching character encryption and decryption keys, and a new matching character encrypted font for subsequent requests for the electronic text.

15. The method of claim 1, further comprising:
generating a new set of matching character encryption and decryption keys and matching character encryption font when the electronic text is requested to be viewed.

16. The method of claim 1, wherein the electronic text includes a plurality of text sections, the method further comprising:
character encrypting at least two of the text sections by reassigning character codes of different electronic text sections using different non-standard text encoding schemes for each of the different text sections.

17. The method of claim 16, further comprising:
generating different matching character encryption and decryption keys for different character encrypted text sections, the different matching character encryption and decryption keys configured to decrypt a corresponding character encrypted text section by reassigning character codes from the corresponding character encrypted electronic text section to a standard text encoding scheme.

18. The method of claim 16, further comprising:
generating different matching character encrypted fonts for different character encrypted text sections, the different matching character encrypted font configured to enable the output device to display a corresponding character encrypted text section in unencrypted form without decrypting the corresponding character encrypted text section.

19. The method of claim 18, wherein the different matching character encrypted fonts have different typefaces to show different glyphs.

20. The method of claim 1, wherein the matching character encrypted font is located on a remote computer.

21. The method of claim 20, further comprising:
generating the character encrypted text with an embedded electronic link reference to the matching character encrypted font at the remote computer.

22. The method of claim 21, further comprising:
receiving an electronic request for the electronic text from a user device comprising the output device;
in response to the electronic request, downloading the matching character encrypted font to the user device from the remote computer using the embedded electronic link reference; and
displaying the character encrypted electronic text via the output device in unencrypted form without decrypting the character encrypted text.

23. The method of claim 22, wherein the downloaded matching character encrypted font is a transient matching character encrypted font, the method comprising:
deleting the transient matching character encrypted font at the user device upon closing a computer application used to display the character encrypted electronic text in unencrypted form.

24. The method of claim 21, further comprising:
masking the embedded electronic link reference to the matching character encrypted font at the remote location.

25. The method of claim 1, wherein the character encrypted text includes a text string, the method further comprising:
presenting the character encrypted text on a user device in unencrypted form without decrypting the character encrypted text;
receiving user text entered via the user device; and
enabling a next electronic action if the user entered text matches the presented unencrypted text.

26. The method of claim 25, wherein the next electronic action is electronically accessing a secure account.

27. The method of claim 25, wherein the next electronic action is electronically creating a secure account.

28. A computer program product stored in at least one storage device and executable by at least one processor to perform a method of encrypting text in electronic content, the method comprising:
accessing electronic text from the at least one storage device;
generating a character encrypted electronic text using a non-standard text encoding scheme to electronically reassign character codes of the electronic text; and
generating a matching character encrypted font configured to enable an output device to display the character encrypted electronic text in unencrypted form without decrypting the character encrypted text.

29. A character encryption system comprising:
at least one storage device including an electronic text;
an encryption application executable by at least one processor to generate matching character encryption and decryption keys and a matching character encrypted font; and
an encryption module executable by at least one processor to character encrypt the electronic text using the matching character encryption and decryption keys,
wherein, using the matching character encrypted font, the character encrypted electronic text can be displayed at an output device in unencrypted form without decrypting the character encrypted text.

30. A character encrypting user input device, comprising:
one or more processors configured to execute computer program code stored in at least one non-transitory storage device;
at least one user input mechanism; and
an encryption module executable by the one or more processors to character encrypt electronic textual inputs received via the at least one user input mechanism, using a non-standard text encoding scheme to electronically reassign character codes of the received electronic textual inputs.
